(19) United States
(12) Patent Application Publication
(10) Pub. No.: US 2026/0051699 A1
(43) Pub. Date: Feb. 19, 2026

(54) DOUBLE TERMINAL POSITION ASSURANCE DEVICE FOR DIFFERENT CAVITY PITCHES

(71) Applicant: Aptiv Technologies AG, Schaffhausen (CH)

(72) Inventors: Uvaraj GANESAN, Tamil Nadu (IN); Romain SAVINA, Saint Martin de (FR); Sylvain LOAS, Le Gault Saint Denis (FR); Laurent DELESCLUSE, Saint Piat (FR)

(21) Appl. No.: 19/299,782

(22) Filed: Aug. 14, 2025

(30) Foreign Application Priority Data
Aug. 14, 2024 (EP) 24194595.5

(51) Int. Cl. H01R 13/629; H01R 13/631

(52) U.S. Cl. CPC H01R 13/62922; H01R 13/631; H01R 2201/26

(57) ABSTRACT

An electrical connector assembly includes a connector housing configured to receive multiple terminals and a terminal header arranged within the housing. The terminal header comprises a first region with a first pitch between terminals and a second region with a second pitch, the first pitch being larger than the second pitch. The assembly further includes first and second terminal position assurance (TPA) members mounted to the connector housing and movable relative to the housing between pre-lock and final lock positions. The first TPA member is associated with the first region of the terminal header, while the second TPA member is associated with the second region. This configuration enables secure positioning and locking of terminals with differing pitches within the connector housing.

### CROSS-REFERENCE TO RELATED APPLICATION

This application claims the benefit of and priority to European Application No. 24194595.5 filed with the European Patent Office on Aug. 14, 2024, the contents of which are incorporated by reference herein.

### TECHNICAL FIELD

The present disclosure generally relates to electrical connectors, specifically to terminal position assurance (TPA) mechanisms within electrical connector assemblies.

### BACKGROUND

In the automotive industry, connectors are subjected to vibrations, mechanical stresses, and environmental factors that can compromise the integrity of electrical connections. It is further of utmost importance that all electrical terminals are correctly mounted in their respective connector housing. Traditional connectors often lack adequate mechanisms to ensure that terminals are properly seated and locked in place, leading to potential misconnections, disconnections, signal loss, or electrical failures. To mitigate these issues, Terminal Position Assurance (TPA) mechanisms have been developed. TPAs provide additional security by verifying the correct mounting of terminals and/or by (additionally) locking terminals in position, ensuring they do not move or dislodge from the connector housing. However, existing TPA designs may still face challenges, such as complexity in assembly, difficulty in ensuring precise terminal positioning, and the need for flexibility to accommodate terminals with different pitches.

Thus, there is a demand for TPA mechanisms that address the need for terminals with different pitches.

It is thus an object of the present disclosure to provide an improved TPA mechanism. It is a further object to provide a TPA that can be utilized on terminals with different pitches.

### SUMMARY

An aspect of the invention relates to an electrical connector assembly, including a connector housing configured to receive a plurality of terminals; a first and a second terminal position assurance (TPA) member (also denoted herein as TPA). The first and the second TPA members are configured to be mounted to the connector housing and being movable relative to the connector housing between a pre-lock position and a final-lock position; a terminal header arranged in the connector housing including a first region having a first pitch between the terminals and a second region having a second pitch, wherein the first pitch is larger than the second pitch, where the first TPA is associated with the first region and the second TPA is associated with the second region.

In a preferred embodiment, the electrical connector assembly is used in applications where secure and reliable connections are important. The different pitches in the terminal header (i.e., an integral or separate part of the housing configured to receive electrical contact terminals therein) allow for varying terminal requirements, optimizing space and functionality within the connector. The TPA members ensure that terminals are properly seated and locked in place, reducing the risk of connection failures due to vibration or handling. This design enhances the assembly's durability and performance, making it suitable for high-stress environments. The TPA members can be moved along the connector housing from a pre-lock to a final-lock position, thus casing the assembly process and improving the reliability of the TPA locking procedure.

This embodiment can be improved when the first and the second TPA include connecting means to connect the first and the second TPA with each other, such that the second TPA is moved by the first TPA, when the first TPA is moved from its pre-lock position to its final-lock position.

Such a connection mechanism between the first and second TPA members simplifies the assembly process. For example, when an assembler installs the connector, moving just the first TPA automatically secures both regions of terminals simultaneously. This interconnected movement ensures consistent and reliable terminal locking, reducing the likelihood of errors during installation. Additionally, this feature saves time and effort, enhancing the overall efficiency and reliability of the connector assembly.

This embodiment is improved when the connecting means are configured such that the second TPA is moved by a smaller distance than the first TPA, when the first TPA is moved from its pre-lock position to its final-lock position.

Such a difference in movement of the first and second TPAs allows for precise control over the locking mechanism in each region of the connector assembly. This feature enables that the terminals in the second region, which may require less movement to secure, can still be secured with a single activating movement. It provides a more tailored locking mechanism that can accommodate different terminal sizes and pitches within the same assembly, offering greater versatility and reliability in various applications.

This embodiment can further be improved when the connecting means of the first TPA includes a driver and the connecting means of the second TPA includes a follower configured to engage with the driver upon movement of the first TPA from its pre-lock position to its final-lock position.

A driver and follower mechanism ensures smooth and coordinated movement between the first and second first and second TPAs. When, for instance, an assembler pushes the first TPA into the final-lock position, the driver on the first TPA engages the follower on the second TPA, effectively moving it to the final-lock position as well. This engagement mechanism ensures that both first and second TPAs lock securely with minimal effort, reducing the risk of incomplete connections. The driver and follower system provides reliable and consistent terminal positioning, which is important for maintaining electrical integrity and performance in high-vibration environments such as vehicles.

This embodiment is further improved when the driver and the follower are not engaged in pre-lock position.

Such a separation of the driver and follower in the pre-lock position ensures that each TPA can be independently positioned initially. Such a design allows an assembler to place the first and second TPAs into their pre-lock positions without immediately triggering the final-lock engagement. This independent positioning can simplify the alignment of terminals during the assembly process. When the first TPA is eventually moved to its final-lock position, the driver engages the follower on the second TPA, ensuring synchronized movement for secure terminal locking. This engagement can ensure that all terminals are correctly seated before final locking occurs, enhancing the reliability and case of use of the connector assembly.

This embodiment can further be improved when the driver engages the follower only after the first TPA is moved from the pre-lock position to the lock position by a distance d, wherein the distance d is preferably in the range of 0.5 mm to 1.5 mm, even more preferably in the range of 0.7 mm to 1.3 mm, most preferably in the range of 0.9 mm to 1 mm.

The specified movement distance d allows the first TPA to move a short, controlled distance before engaging the second TPA. This delay ensures that terminals are properly seated and positioned before the second TPA begins its movement. Such a range, for instance 0.5 mm to 1.5 mm, can offer an optimized balance between case of movement and secure engagement, minimizing the risk of premature or incomplete locking. This feature enhances the reliability of the connector assembly, ensuring consistent electrical connections and reducing the likelihood of installation errors.

This embodiment is further improved when the driver includes a hook, and the follower includes a counter-hook configured to engage with the driver upon movement of the first TPA from its pre-lock position to its final-lock position.

Such a hook and counter-hook mechanism can provide a robust and secure engagement between the first and second TPAs. For example, when the first TPA is pushed into its final-lock position, the hook on the first TPA catches onto the counter-hook on the second TPA. This hook-and-counter-hook design ensures a firm and reliable connection, preventing the first and second TPAs from disengaging under vibration or stress. The secure locking provided by this mechanism enhances the overall stability and durability of the connector assembly, making it suitable for demanding environments. Additionally, this design simplifies the assembly process by providing clear tactile feedback when the first and second TPAs are correctly engaged, reducing the likelihood of installation errors.

Further improvement is achieved when the first and the second TPA members are configured to form a telescopic connection, wherein the telescopic connection has an extended and a collapsed condition, so that the first TPA member and the second TPA member form a form fit connection when the telescopic connection is in the extended and/or collapsed condition.

Such a telescopic connection between the first and second TPAs allows for flexible and secure engagement. This design ensures that the first and second TPAs can slide into each other, either extending or collapsing as needed, to form a fit. This telescopic feature accommodates variations in terminal positions and connector housing sizes, providing a reliable connection even in compact or irregular spaces. The form fit connection in both extended and collapsed conditions ensures that the first and second TPAs remain securely locked, preventing accidental disconnections. This versatility enhances the connector assembly's configurability and reliability, making it suitable for various applications where space constraints and secure connections are important.

Even further improvement can be achieved when the connecting means of the first TPA member includes an L-shaped structure wherein the stem of the L-shape extends parallel to the movement direction of the first and second TPAs and perpendicular to the mating axis and the leg of the L-shape extends parallel to the mating axis, and the connecting means of the second TPA member includes an L-shaped structure wherein the stem of the L-shape extends parallel to the movement direction of the first and second TPAs and extends perpendicular to the mating axis and the leg of the L-shape extends parallel to the mating axis, wherein the legs of the L-shape structures extend in opposite direction when assembled, such that the respective legs engage when the first TPA is moved from its pre-lock position to its final-lock position.

Such L-shaped structures provide a precise and secure engagement mechanism for the first and second TPAs. For instance, the L-shaped design ensures that as the first TPA moves into the final-lock position, the legs of the L-shapes from both first and second TPAs interlock securely. This interlocking mechanism enhances the stability and reliability of the connection, ensuring that the terminals remain securely locked even under vibrations or other stresses. The opposing direction of the legs allows for firm engagement with minimal movement, reducing the risk of accidental disconnection. This design improves the case and accuracy of assembly, ensuring consistent and reliable terminal positioning.

Even further improvement is gained when the first TPA member and the second TPA member partially overlap in mounted condition, wherein in the overlap region both first and second TPAs have the same pitch.

Overlapping the first and second TPAs can ensure consistent terminal spacing in the overlap region, which can be important for maintaining reliable electrical connections. For instance, this overlap provides additional stability and alignment precision for the terminals. Having the same pitch in the overlap region ensures that there is no mismatch or misalignment between the terminals of the first and second TPAs. Additionally, the overlap provides a compact and efficient design, optimizing space within the connector housing while maintaining secure and reliable terminal connections.

Further improvement is achieved, when in mounted condition, the first TPA member is arranged to be accessible from outside of the connector housing, to allow operating the first TPA member.

Making the first TPA accessible from the outside of the connector housing simplifies the installation and maintenance process. For example, an assembler can easily access and operate the first TPA without needing to disassemble the entire connector housing. This external accessibility allows for quick and efficient locking or unlocking of the terminals, enhancing the case of use, and reducing the time required for installation or repairs. Additionally, this design minimizes the risk of damaging other components during operation, as the technician does not need to manipulate the internal parts of the connector assembly.

Even further improvement can be achieved when the first pitch is in the range of 2.6 mm to 4.4 mm, preferably in the range of 3 mm to 4 mm, more preferably in the range of 3.2 mm to 3.8 mm, most preferably 3.5 mm and/or the second pitch is in the range of 1 mm to 2.6 mm, preferably in the range of 1.4 mm to 2.2 mm, more preferably in the range of 1.6 mm to 2 mm, most preferably 1.8 mm.

Such specific ranges for terminal spacing optimize the connector assembly for various electrical requirements. For instance, a larger pitch in the first region (in the range of 2.6 mm to 4.4 mm) might accommodate higher power or signal lines that need more space to prevent interference. A smaller pitch in the second region (in the range of 1 mm to 2.6 mm) could allow for a denser arrangement of lower power or signal lines, making efficient use of space without compromising performance. Such a design can ensure that the connector can accommodate a range of electrical currents and signals effectively. Precise pitch specifications can enhance the reliability of the connections by ensuring consistent and adequate spacing, which helps prevent short circuits and signal crosstalk, thus improving the overall performance and safety of the electrical system.

Further improvement is gained when the first TPA member includes guiding rips, configured and dedicated for guiding a shifting movement relative to the second TPA member in mounting condition.

Guiding ribs on the first TPA member facilitate smooth and accurate movement during assembly and operation. These guiding ribs can ensure that the first TPA moves precisely in relation to the second TPA, reducing the risk of misalignment and/or jamming. Such a design feature simplifies the installation process, allowing for easier and more reliable engagement of the first and second TPAs. The guiding ribs also help maintain the correct positioning of the first and second TPAs over time, even in environments subject to vibration and mechanical stress. This enhances the durability and performance of the connector assembly, ensuring secure and consistent terminal locking.

Further improvement is achieved when the housing includes a stopper feature configured and dedicated to prohibiting movement of the second TPA member in the direction of movement of the first TPA member when moving from the pre-lock to the lock position.

Such a stopper in the housing can ensure that the second TPA remains stationary until it is specifically engaged by the movement of the first TPA. For example, this feature prevents accidental or unintended movement of the second TPA during the initial positioning of the first TPA. The stopper ensures that the second TPA only moves when the first TPA reaches the correct position, allowing for a controlled and deliberate locking sequence. This prevents premature engagement and ensures that all terminals are properly seated before the second TPA locks them into place. This design enhances the reliability and accuracy of the connector assembly, ensuring secure and consistent terminal connections, which are important for maintaining electrical integrity in various applications.

Further improvement is achieved when at least one TPA member includes locking elements configured to lock the terminals in locked position.

Including locking elements on the TPA members can ensure that the terminals remain securely fixed once they are in place. For example, these locking elements might grip or snap onto the terminals, preventing them from loosening due to vibrations or mechanical stresses. This secure locking mechanism is important for maintaining consistent and reliable electrical connections. The locking elements provide an added layer of security, ensuring that once the terminals are locked, they remain firmly in place throughout the lifespan of the connector assembly. This design enhances the durability and performance of the connector.

### BRIEF DESCRIPTION OF THE DRAWINGS

In the following, preferred embodiments of the disclosure are disclosed by reference to the accompanying figure, in which shows:

FIG. 1 illustrates an isometric view of a connector assembly set according to some embodiments.

FIG. 2 shows an isometric view of a first TPA member according to some embodiments.

FIG. 3 shows an isometric view of a second TPA member according to some embodiments.

FIG. 4A shows an isometric view of the first and second TPA members in a pre-lock position according to some embodiments.

FIG. 4B shows a close-up isometric view the first and the second TPA members of FIG. 4A according to some embodiments.

FIG. 5A shows a top view of the first and the second TPA members of FIG. 4A in a final lock position mounted in a housing according to some embodiments.

FIG. 5B shows a top view of the first and the second TPA members of FIG. 5A a pre locked position according to some embodiments.

FIG. 6 shows a close-up isometric view of locking elements of the second TPA member of FIG. 5A according to some embodiments.

FIG. 7 shows a top view of a terminal header according to some embodiments.

### DETAILED DESCRIPTION

The subsequent sections provide a detailed description of the invention, referencing the accompanying illustrations for clarity. The descriptions represent examples only and are not intended to limit the invention's scope. Identical reference numerals across the figures and text denote the same components. The illustrations may not reflect actual size or scale; their dimensions, proportions, and depictions of elements might be enhanced in the drawings for better understanding and visual convenience.

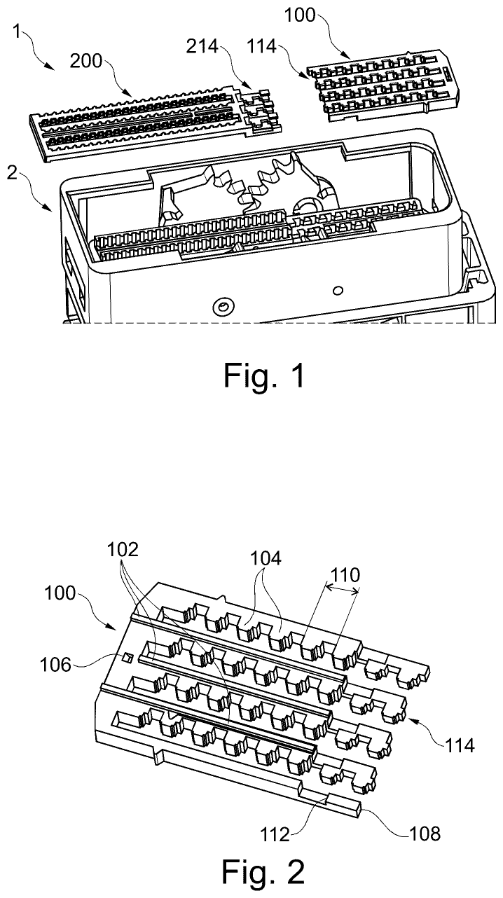

FIG. 1 illustrates an electrical connector assembly 1 according to the invention. A first TPA member 100 and a second TPA member 200 are depicted before they are mounted in a connector housing 2. The first TPA member 100 and the second TPA member 200 are mounted such that the connecting means 114 of the first TPA member 100 and the connecting means 214 of the second TPA member are overlapping.

The overlapping connecting parts of the first and second TPA members ensure a secure and stable connection within the housing. For instance, this overlap can provide additional mechanical strength and alignment, preventing the first and second TPAs from shifting out of place. The design facilitates easy and accurate assembly, as the overlapping parts guide the first and second TPAs into the correct position, ensuring that the terminals are properly aligned and locked. This feature enhances the possibility to move the second TPA by only moving the first TPA, as the movement will be transferred via the connecting means 114, 214.

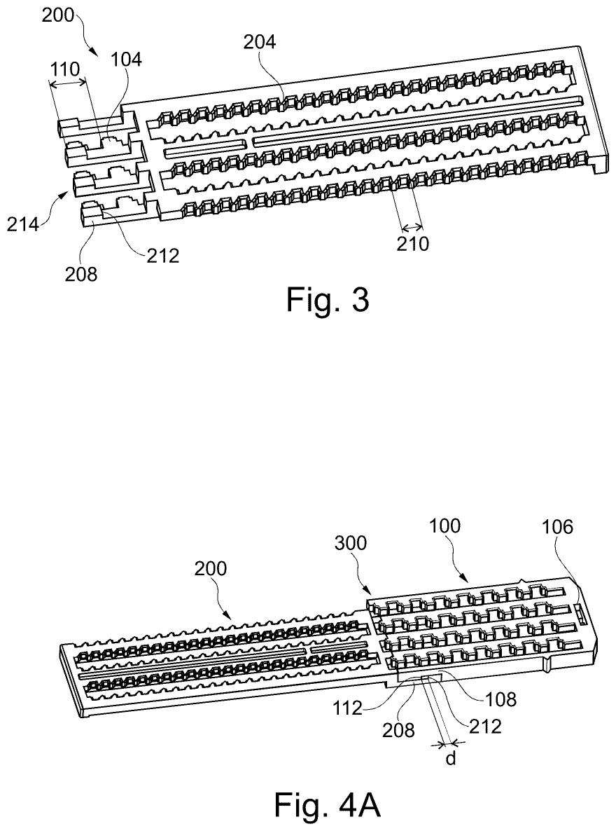

FIG. 2 depicts a first TPA member 100 according to the invention. Guiding rips 102 are visible on the top side of the TPA member 100. Locking elements 104 are arranged on the TPA member with a first pitch 110. A slot 106 is positioned on the TPA. The connecting means 114 include an L-shape structure 108 and a driver 112. The slot 106 provides accessibility, so that the TPA can be moved, e.g., by a tool that fits into the slot 106. The guiding rips 102 provide guidance for the movement inside the housing 2. The L-shape structure 108 facilitates the engagement with the L-shape structure 208 (see FIG. 3) of a second TPA 200 (see FIG. 3), so that the driver 112 can engage with the follower 212 (see FIG. 3) of the second TPA.

Guiding rips 102 ensure precise and smooth movement within the connector housing, aiding in proper alignment and reducing the risk of misalignment during installation. The slot 106 provides an easy access point for e.g., tools, simplifying the operation of the TPA, which is particularly useful in tight or hard-to-reach spaces. The locking elements 104 arranged with a specified first pitch 110 ensure that terminals are securely locked in place, maintaining reliable electrical connections. The L-shaped structure 108 and driver 112 are designed to engage effectively with the second TPA's follower 212, ensuring synchronization and secure locking of the terminals in both first and second TPAs.

FIG. 3 shows a second TPA member 200 according to the invention. Locking elements 104, 204 are arranged on the TPA member with a first pitch 110 and a second pitch 210. The connecting means 214 includes an L-shape structure 208 and a follower 212. The L-shape structure 208 facilitates the engagement with the L-shape structure 108 (see FIG. 2) of the first TPA 100 (see FIG. 2), so that the follower 212 can engage with the driver 112 (see FIG. 2) of the first TPA.

The second TPA member's dual-pitch arrangement allows it to accommodate terminals with different spacings within the same connector assembly, while maintaining a space requirement for the TPA as low as possible. For instance, having locking elements with both a first pitch 110 and a second pitch 210 provides flexibility to secure terminals that require different spacing due to varying electrical or mechanical requirements. The L-shaped structure 208 ensures precise engagement with the corresponding L-shaped structure 108 on the first TPA member 100, facilitating a smooth and reliable locking process. The follower 212 engaging with the driver 112 from the first TPA ensures that both first and second TPAs lock in together, enhancing the stability and reliability of the terminal connections.

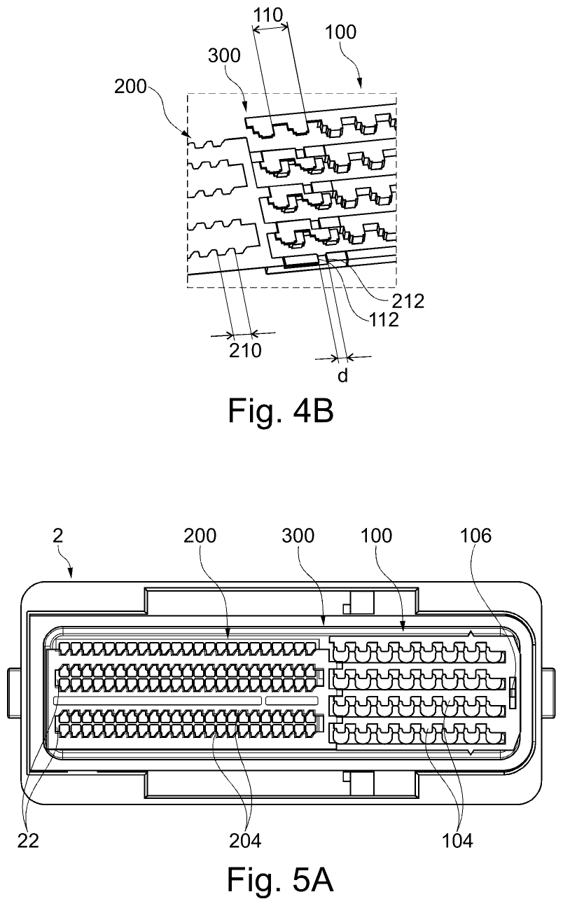

FIG. 4A shows a first and a second TPA member according to the invention member in a lock position an isometric view. Here the first TPA 100 and the second TPA 200 overlap in the overlap region 300. In the lock position, the first TPA 100 and the second TPA 200 are in a collapsed condition, so that the distance d between the driver 112 and the follower 212 formed by the overlapping L-shape structures 108, 208 is maximal. A slot 106 is visible on the first TPA member 100 and facilitates movement of the first TPA member.

The overlap of the first and second TPA members in the lock position ensures a compact and secure connection. For instance, this overlapping design helps to maintain alignment and stability of the terminals, preventing any movement that could disrupt the electrical connection. The slot (106) on the first TPA provides easy access for a tool, facilitating the movement of the TPA members from the pre-lock to the lock position. This design improves the reliability and case of installation, ensuring that the terminals are securely locked and reducing the risk of connection failures due to vibration or mechanical stress.

FIG. 4B shows the first and the second TPA member of FIG. 4A in a close-up cross-sectional and isometric view. Here the different pitches 110 and 210 on the first TPA 100 and second TPA 200 are visible. The overlap region includes the first pitch 110 on both TPA members 100, 200. The distance d is the distance between the follower 212 and the driver 112.

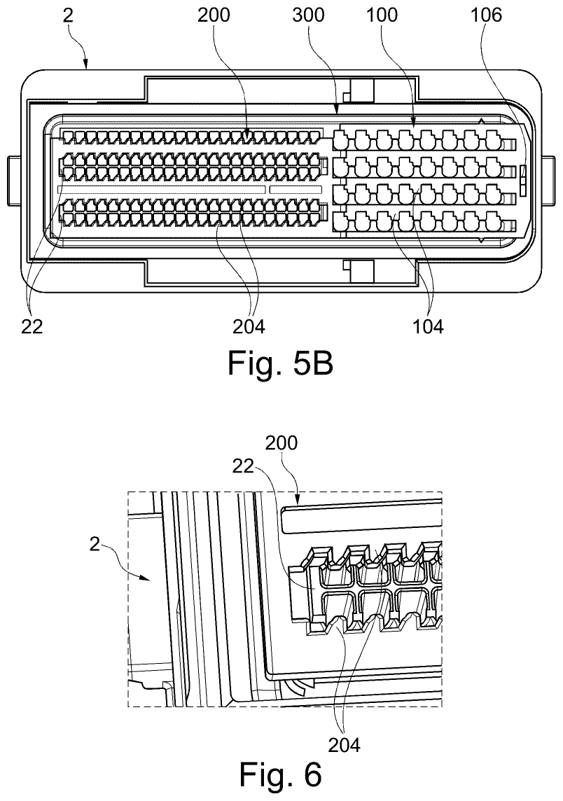

FIG. 5A depicts the first and the second TPA members 100, 200 of FIG. 4A in a final lock position mounted in a housing 2 in a top view. The first TPA 100 and the second TPA 200 overlap in the overlap region 300. TPA members, 100, 200 are mounted in the housing 2. A slot 106 is provided to move the first TPA 100 and a stopper feature 22 is provided on the housing 2 to prohibit movement of the second TPA member 200 beyond a certain position. Locking elements 104, 204 block the installation way for terminals (not shown).

Such a configuration can ensure that both TPA members are securely locked and aligned within the housing 2. For example, the overlap region 300 where both first and second TPAs 100, 200 meet ensures that the terminals remain stable and aligned, providing a reliable electrical connection. The slot 106 allows a tool to easily move the first TPA 100 into place and thus moving also the second TPA 200, thereby simplifying the locking process. The stopper feature 22 in housing 2 ensures that the second TPA 200 does not move beyond its intended position, preventing accidental disengagement or misalignment. In this configuration, installed terminals cannot be removed from the first and second TPAs and/or terminals cannot be installed, as the way through the housing is blocked by the locking elements 104, 204 of the first and second TPAs.

FIG. 5B shows the first and the second TPA member of FIG. 5A in a pre-locked position mounted in a housing 2 in a top view. The first TPA 100 and the second TPA 200 overlap in the overlap region 300. TPA members 100, 200 are mounted in the housing 2. A slot 106 is provided to move the first TPA 100 and a stopper feature 22 is provided on the housing 2 to prohibit movement of the second TPA member 200 beyond a certain position. Locking elements 104, 204 open the installation way for terminals (not shown). The second TPA member 200 is in contact with the stopper feature 22.

The pre-locked position allows for easy installation of terminals. For example, the overlapping region 300 ensures initial alignment and stability of the first and second TPAs, which helps in accurately positioning the terminals before final locking. The slot 106 provides access for a tool to move the first TPA 100 into the final lock position. The stopper feature 22 ensures that the second TPA 200 does not move beyond the intended position, maintaining proper alignment. The positioning of the locking elements 104, 204 opens the way for terminals to be installed, ensuring that they are properly seated before final locking.

FIG. 6 depicts the locking elements 204 of a the second TPA member of FIG. 5A in a close-up isometric view. The TPA member 200 is in a lock position, so that the locking elements 204 are blocking the way for terminals to be installed. The stopper feature 22 is not engaging the TPA member 200, so that movement of the TPA member is possible.

Such a configuration ensures that terminals cannot be installed or removed once the TPA member is in a locked position, preventing accidental or improper installation. For instance, the locking elements 204 block the terminal paths, ensuring that all terminals are securely in place before the TPA member is locked. The fact that the stopper feature 22 is not engaging the TPA member 200 indicates that the TPA can be moved in the pre lock position.

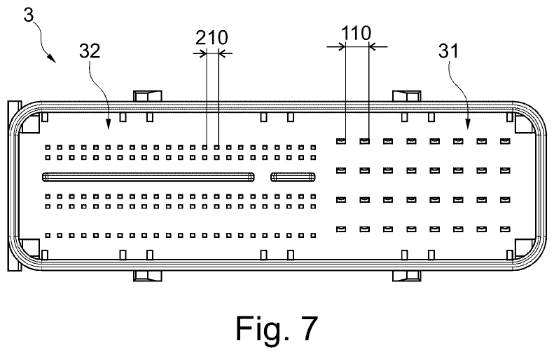

FIG. 7 shows a top view of a terminal header 3 according to an embodiment. The terminal header 3 includes a first region 31 with a first pitch 110 and a second region 32 with a second pitch 210. In the embodiment shown, the header 3 is an integral part of the housing 2 and serves to receive various electrical contact terminals. It may also be provided as a separate insert part, which is mounted to the housing.

A terminal header 3 with distinct pitch regions allows flexible terminal spacing to meet different electrical or mechanical requirements. For instance, the first region 31 with the first pitch 110 might accommodate higher power terminals that require more space to prevent electrical interference or overheating. The second region 32 with the second pitch 210 can accommodate lower power or signal terminals that can be placed closer together, optimizing space within the connector. Such a terminal header type with varying pitches can be securely installed with the double TPA configuration according to the invention.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### LIST OF REFERENCE SIGNS

1 connector assembly
2 connector housing
3 terminal header
22 stopper feature
31 first region
32 second region
100 first TPA member
102 guiding rips
104 locking elements
106 slot
108 L-shaped structure
110 first pitch
112 driver
114 connecting means
200 second TPA member
204 locking elements
208 L-shaped structure
210 second pitch
212 follower
214 connecting means
300 overlap region
d distance

1. An electrical connector assembly, comprising:
a connector housing configured to receive a plurality of terminals;
a first and a second terminal position assurance (TPA) member, wherein the first and the second TPA members are configured to be mounted to the connector housing and being movable relative to the connector housing between a pre-lock position and a final lock position; and
a terminal header arranged in the connector housing including a first region having a first pitch between the terminals and a second region having a second pitch, wherein the first pitch is larger than the second pitch, wherein the first TPA member is associated with the first region and the second TPA member is associated with the second region.

2. The connector assembly according to claim 1, wherein the first and the second TPA members include connecting means to connect the first and the second TPA members with each other, such that the second TPA member is moved by the first TPA member, when the first TPA member is moved from its pre-lock position to its final-lock position.

3. The connector assembly according to claim 2, wherein the connecting means of the first TPA member includes an L-shaped structure, wherein a stem of the L-shape extends parallel to a movement direction of the first and second TPA members and perpendicular to a mating axis and a leg of the L-shape extends parallel to the mating axis, and the connecting means of the second TPA includes an L-shaped structure, wherein the stem of the L-shape extends parallel to the movement direction of the first and second TPA members and extends perpendicular to the mating axis and the leg of the L-shape extends parallel to the mating axis, and wherein the legs of the L-shape structures extend in opposite direction when assembled, such that the respective legs engage when the first TPA member is moved from its pre-lock position to its final-lock position.

4. The connector assembly according to claim 2, wherein the connecting means are configured such that the second TPA member is moved by a smaller distance than the first TPA member when the first TPA member is moved from its pre-lock position to its final-lock position.

5. The connector assembly according to claim 2, wherein the connecting means of the first TPA member includes a driver and the connecting means of the second TPA member includes a follower configured to engage with the driver upon movement of the first TPA member from its pre-lock position to its final-lock position.

6. The connector assembly according to claim 5, wherein the driver and the follower are not engaged in pre-lock position.

7. The connector assembly according to claim 5, wherein the driver engages the follower only after the first TPA member is moved from the pre-lock position to the lock position by a distance, wherein the distance is in a range of 0.5 mm to 1.5 mm.

8. The connector assembly according to claim 5, wherein the driver includes a hook and the follower includes a counter-hook configured to engage with the driver upon movement of the first TPA member from its pre-lock position to its final-lock position.

9. The connector assembly according to claim 1, wherein the first and the second TPA members are configured to form a telescopic connection, wherein the telescopic connection has an extended and a collapsed condition, so that the first TPA member and the second TPA member form a form fit connection when the telescopic connection is in the extended and/or collapsed condition.

10. The connector assembly according to claim 1, wherein the first TPA member and the second TPA member partially overlap in mounted condition, wherein in an overlap region of the first and second TPA members have the same pitch.

11. The connector assembly according to claim 1, wherein in mounted condition, the first TPA member is arranged to be accessible from outside of the connector housing, to allow operating the first TPA member.

12. The connector assembly according to claim 1, wherein the first pitch is in a range of 2.6 mm to 4.4 mm.

13. The connector assembly according to claim 1, wherein the first TPA member includes guiding rips configured to guide a shifting movement relative to the second TPA member in mounting condition.

14. The connector assembly according to claim 1, wherein the housing includes a stopper feature configured and dedicated to prohibiting movement of the second TPA member in a direction of movement of the first TPA member when moving from the pre-lock to the lock position.

15. The connector assembly according to claim 1, wherein at least one of the first and second TPA members includes locking elements configured to lock the terminals in locked position.
